(19) United States
(12) Patent Application Publication
(10) Pub. No.: US 2010/0163153 A1
(43) Pub. Date: Jul. 1, 2010

(54) Particle Agglomeration Process for Wood and Cork Industrial Sectors

(76) Inventors: Joâo Carlos Almeida Ribeiro Claro, Vila Real (PT); António José Ragageles Valente, Estarreja (PT); Artur Da Rosa Pires, Ilhavo (PT)

Correspondence Address: CERMAK KENEALY VAIDYA & NAKAJIMA LLP, 515 EAST BRADDOCK RD SUITE B, Alexandria, VA, 22314, US

(21) Appl. No.: 12/531,761

(22) PCT Filed: Aug. 7, 2007
(86) PCT No.: PCT/IB2007/053125

§ 371 Date: Jan. 26, 2010

(30) Foreign Application Priority Data
Mar. 19, 2007 (PT) 103693

(51) Int. Cl. B27N 3/06

(52) U.S. Cl. 156/62.2

(57) ABSTRACT

This invention relates to a particle agglomeration process of wood and cork which uses an agglomerating system consisting of a pre-polymer of hydroxyl terminated polybutadiene (HTPB), a di-isocyanate and possibly a catalyst in order to obtain agglomerations of cork and/or wood particles with new characteristics and with new particle compositions. These products are used in the particle agglomeration industry in the wood sector (wood particles boards), specifically in the panels and veneers sub-sector and in the cork agglomeration industry sub-sector. This process enables the industrial reprocessing of residues and sub-products of sectors of wood and cork and at the same plays its part towards solving environmental problems by creating a viable and profitable alternative to storage and/or burning and/or depositing in the ground, in particular for what is referred to as cork powder and ‘terras’ and some wood residues, in particular fibre and polishing dust.

### TECHNICAL FIELD OF THE INVENTION

This invention refers to a particle agglomeration process of sectors of wood and cork, in particular wood chips, fibre dust, polish dust, saw mill or saw dust and the agglomeration of cork particles usually known as cork granules, cork powder or cork dust (cork particles less than 0.2 mm in size) and ‘terras’ (particles less than 2 mm in size which originate from the exterior surface of the cork planks) for use in the particle agglomeration industry, wood particles boards, veneers, plywood, laminated wood and other panels in the wood sector, often designated as the panels and veneers sub-sector and in the cork agglomerates sub-sector.

### SUMMARY OF THE INVENTION

This process agglomerates particles of sectors of wood and cork including particles classified as sub-products or residues through the use of an agglomerating system which constituted by a pre-polymer of hydroxyl terminated polybutadiene (HTPB), a di-isocyanate and possibly a catalyst.

In this way this invention enables the industrial reprocessing or recovery of residues or wastes and sub-products of sectors of wood and cork and at the same time plays its part in solving environmental problems by creating a viable and profitable alternative to the storage and/or burning and/or depositing in the ground, in particular for what is referred to as cork powder and ‘terras’ and some wood residues, in particular fibre and polishing dust. New products are created through this agglomeration process, such as particle agglomerations with up to 95% cork powder and/or ‘terras’, particle agglomerations with up to 95% sawmill or saw dust and/or fibre dust and/or polish dust. These new agglomerates have good macroscopic characteristics (in relation to the finish quality for use as low granulometry particles) and physical and mechanical properties with a high potential for industrial applications.

### BACKGROUND TO THE INVENTION

The reprocessing or recovery of residues and sub-products is currently a subject which is gaining in importance in corporate strategies for improved productivity. It is becoming more and more common for factors to be introduced and corporate policies to be implemented that take the environment into consideration or which have minimal impact on the environment. The adoption of environmentally-friendly practices were initially imposed by legislation but companies themselves quickly realised that they also could also be a very important factor in productivity, their corporate image and in their relationships with customers, regulators, supervisory authorities and society as a whole. The appropriate treatment of residues and sub-products and in particular their reprocessing is therefore a major corporate concern as soon as they can be translated into a high impact added-value item. Companies operating in the wood and cork sectors, given the strategic importance that they represent for Portugal and the other producer countries, must ensure that they also adopt a ‘pro-active’ attitude of constant improvement and of the quest for better solutions. In this context this invention represents a technological platform of great importance for the industries in those sectors, launching them into a strategic framework characterised by an increase in the productivity and the quality of the products and by a cleaner and more environmentally-friendly production thereby contributing to environmental sustainability. But in particular this invention enables the optimisation of already existing products and—in the case of wood agglomerates—it can overcome difficulties associated with the nature of the raw material itself which at the moment affects the productivity and quality of the final product.

The agglomerates currently used by the wood agglomerate industry (particle agglomerates and fibre agglomerates) are melamine formaldehyde or urea formaldehyde-based products and are often generically described in the sector as ‘resins’. As these agglomerates contain formaldehyde they are subject to European standards (EN 120, EN 312-1, EN 662-1) which aim to regulate and control the maximum concentration of formaldehyde. Reference must be made in this context to the ‘Commission Decision No. 2002/740/EC of Mar. 9, 2002’ which refers as follows in the chapter concerning wood products in point 7: ‘As far as formaldehyde is concerned, agglomerates (panels of particles) used must be of class 1 in quality and must be in compliance with the EN 312-1 standard’.

Formaldehyde is an organic compound and is part of the aldehyde family and in a more generic mode is part of the volatile organic compound (VOC) family. Formaldehyde is one of the chemical compounds included on the list of the main ‘Internal Air Pollutants’ and is directly related to the phenomenon known as ‘Sick Building Syndrome’ which relates to the degradation of air quality inside residential dwellings.

The main source of formaldehyde inside buildings is in wood agglomerates, used frequently as a construction material and for furniture. According to a study currently underway in the EU, formaldehyde is one of the substances which could be considered as a prime substance in any definition of interior air quality with wood agglomerates being one of the sources indicated of this pollutant.

It also states that a company producing wood agglomerates must refer in its ‘Storage Conditions’ for slabs or panels of particle agglomerations that ‘they must be stored in a dry and ventilated location.’

These types of pollutants may cause serious public health problems and in particular due to risks that contribute to various illnesses such as allergies, respiratory difficulties, headaches, vertigo, nausea, irritations of the ears, skin and respiratory channels, loss of intellectual capacities and cancer—with children being the most susceptible to these effects.

The importance of this problem is evident in the formal agreement between the LQAI—Laboratory of Interior Air Quality, the Unit of Advanced Energy Studies in the Construction Environment and the Faculty of Sciences at the University of Oporto for the ‘Assessment of the quality of construction materials in terms of emissions in accordance with the criteria drawn up by the various European norms and protocols, in particular: ECA (European Collaborative Action), GVE (Association for the Control of Emissions in Products for Flooring Installation), Finnish Society for Indoor Air Quality and Climate’ which includes emission tests of VOC and formaldehyde.

Another problem that is closely linked to the production processes is the fact that the agglomerating capacity of the current melamine-formaldehyde and urea-formaldehyde resins depend on the nature of the particles and their granulometry. In the case of wood particles, the current agglomerates manifest a significant reduction in their efficiency when the particles used originate from hardwoods (such as eucalyptus), in comparison with particles from resinous trees (such as the pine tree) and if they include particles of wood bark. This factor is very important both from a strategic and sector sustainability viewpoint, given the increased proliferation of the eucalyptus and its lower commercial value in relation to the pine tree and given also the lower commercial value of bark woodchip.

With the current agglomerates there is still a limitation in the percentage of smaller sized particles (for example saw mill) that can be included in the formulation of agglomerates of fibre dust and polish dust. In the cork sector the current agglomerates also have limitations in what is referred to as low granulometry particle agglomeration.

In the cork sector, cork powder for example, due to its low granulometry (particles less than 0.2 mm in size) is not included in the vast majority of agglomerates and when it is used, only in a low percentage. To date cork powder agglomerates obtained have not shown any properties which will enable their full implementation on an industrial scale.

Therefore the process which is the subject of this invention may constitute an alternative to the current processes for producing cork agglomerates and will also enable the agglomeration of low granulometry cork particles (particles less than 0.2 mm in size commonly known as cork powder) and other residues such as the particles originating form the exterior surface of the cork wedges, commonly known in the Portuguese cork industry as ‘terras’, ‘P3’ or ‘0.5-1.0 weak’.

Through the process which is the subject of this invention, cork particle agglomerates are produced which include for example cork powder, ‘terras’, ‘P3’ or ‘0.5-1.0 weak’ in which the percentage proportion between the various particles may vary from 0 (zero) to 100%, or in other words, agglomerates may be obtained in which the particle composition is solely of particles of cork powder, ‘terras’ or ‘P3’ or ‘0.5-1.0 weak.’

Therefore the process which is the subject of this invention enables the production of agglomerated panels with a mixture of different types of cork particles in a range of proportions from 0-100% thereby creating cork agglomerates with densities between 200 and 1100 kg/m³, a breaking resistance between 0.100-5,200 MPa, a modulus between 50.40 and 98.90 MPa and a distortion percentage between 5.005 and 50.06%.

Therefore for cork residues (cork powder, ‘P3’; ‘terras’ and ‘0.5-1.0 weak’), considered as industrial residues (Code LER 03 01 99), problems have been identified with their drainage and storage and also with their harmful effects on environments.

The study by the Industrial Association of the District of Aveiro (‘Multi-Sector Study on the Area of Environment’, 2000) must be highlighted here. This study explicitly refers on page 61 to the fact that ‘The production of cork powder is, inclusively, responsible for some physiographical changes verified in the Council of Santa Maria da Feira (small valleys that disappear due to the continual deposition of cork powder from them)’. However, according to references in the study of Prof. Luís Cabral e Gil: ‘Cork Processing Technology and Chemical Constitution’, INETI, the cork powder has had its main use as a combustible fuel for producing energy (burns in kilns), with a small fraction of the remainder being used for filling in corks of a lower quality, in linoleum factories, in the control of soils, etc.’

The document FR2621524A1 describes a cork agglomerate for acoustic insulation composed of cork particles and a polyurethane-based cork agglomerate. This type of agglomerate is identical to that used currently by the cork agglomerates industry and differs from the agglomerate disclosed in this invention to the extent that it does not use a pre-polymer of hydroxyl terminated polybutadiene (HTPB) as a basis for the agglomerating system, thereby forming a different agglomerating system which does not permit its use for example in the production of cork particle agglomerates with a granulometry lower than 0.2 mm.

The document FR2656250A1 describes a mixed agglomerate of wood and cork (compound material) consisting of wedges of agglomerated cork particles and wedges of wood plywood, juxtaposed and stuck successively together in order to form a panel. This panel is used to produce furniture or decorative items and differs from the disclosure in this invention to the extent that it claims to only disclose the process of obtaining a material for a successive sticking of various lamellas of cork agglomerate and wood plywood and not the agglomeration process using an agglomerate or ligand, used by the cork agglomerate or the glue for the successive sticking of the lamellas, referring generically to the process used by a cork agglomerate and a glue or a glueing process.

Document U.S. Pat. No. 5,932,680 describes the possibility of using—amongst many other reagents—polyisocyanates and polybutadiene diol which differs from what is being introduced in this invention by solely disclosing a collection of formulations of polymers and pre-polymers with specific characteristics and their usage as heat blending adhesives in the footwear industry.

Documents U.S. Pat. No. 4,257,996A1, U.S. Pat. No. 4,209,433, U.S. Pat. No. 4,374,791 and U.S. Pat. No. 4,898,776 describe a process that uses polyisocyanates or polyisocyanates in conjunction with phosphates and thiophosphates as a ligand or agglomerate for the production of panels from wood particles. This ligand differs from the disclosure in this invention in so far as it does not use a pre-polymer of hydroxyl terminated polybutadiene groups as its base agglomerating system.

Document PT88239B describes an agglomeration of cork powder which differs from the disclosure in this invention to the extent that despite using the particle type it does not use any type of agglomerate or ligand to obtain it but uses suberin, a natural cork substance and its main constituent and which gives cork cell walls their watertight, elastic and imputrescible properties.

Documents PT94133 and U.S. Pat. No. 6,599,455 describe agglomerates of cork and wood particles which differ the disclosure in this invention to the extent that despite referring to the same type of particles they use thermoplastic ligands and not any type of agglomerate or ligand similar to that used in this invention based on hydroxyl terminated polybutadiene groups. In fact the agglomerating system of hydroxyl/terminated polybutadiene groups and di-isocyanate falls within the definition of a thermosetting polymer as its ‘setting’ is due to a chemical reaction that does not allow any subsequent melting through heating as in the case of thermoplastic polymers.

There are also various documents which refer to the use of similar reagents or reagents from the same chemical family as those presented in this invention in their composition of elastomers, membranes, glues, adhesives and ligands, in particular documents US2004/122176A1, US2001/5509A1, US2004/0170856, US2005/0010013A1, which disclose new formulations of polymers and pre-polymers and in some cases their usage as adhesives or glues for surfaces, slabs or substrates of wood, glass, ceramic etc. These formulations are designed for finishes/treatments of surfaces of various materials in applications such as insulation and waterproofing, shock absorbers for vibration and impact, adhesives and glues which differ from the formulation used in this invention to the extent that agglomerating properties are not disclosed as they are not applicable to the production of particle agglomerations.

### DESCRIPTION OF THE INVENTION

The agglomeration process, the subject of this invention, uses a polymer obtained from the chemical reaction of a pre-polymer of hydroxyl terminated polybutadiene, also referred to as HTPB with a di-isocyanate, such as toluene di-isocyanate (TDI), isofuran di-isocyanate (IPDI) and methylene diphenyl di-isocyanate (MDI).

The reaction between those two reagents creates a final solid polymer with a large particle agglomeration capacity including those of a granulometry lower than 0.2 mm.

A catalyst can be used in this reaction, such as dibutylbis[(1-oxododecyl)oxy]istannate or, more generically, (DBTDL-dibutyltin dilaurate), in order to increase the polymerisation speed.

Due to the low granulometry of some particles the agglomerating system must from the outset have the capacity to involve all the particles in an efficient way in order to distribute itself over a large surface.

The pre-polymer of hydroxyl terminated polybutadiene was selected because of its ability to involve small particles, distributing itself over an extensive surface area. After mixing the pre-polymer with the particles a chemical reaction has to be generated (polymerisation reaction) which will enable the chemical binding of the various chains of pre-polymers in order to obtain a final solid polymer which will foster the efficient agglomeration of the particles.

For this phase di-isocyanates were selected since in addition to generating the intended chemical reaction, their different chemical structure enabled different speeds of reaction and final polymers of different characteristics to be obtained.

In addition to fostering the chemical binding of the various chains of hydroxyl terminated polybutadiene, the di-isocyanates enable links to be established between the chains of the final polymer (inter-chain links or cross-links), creating a reticular structure which bestows a huge mechanical resistance and some flexibility to the final polymer. Because of this fact di-isocyanates are often referred to as ‘reticulants’ or ‘reticulant agents’. Depending on the type of di-isocyanate used different speeds of polymerisation are obtained. However, the speed of this reaction can also be altered by the use of catalysts. This factor is very important from an industrial point of view because here the use of di-isocyanates is more viable and can lead to faster polymerisation speeds using catalysts at the same time.

Therefore from the industrial point of view and particularly in catalyst-reactions, the polymerisation time is frequently less than the time required for the effective mixing of the reagents with the particles, therefore the reagents must not be added to the mixture simultaneously but in phases. In this type of industrial agglomeration the polymerisation process is carried out at a higher temperature than the ambient temperature in order to obtain a faster and more efficient reaction.

The process consists of mixing, in a vertical or horizontal industrial mixer, the particles with the pre-polymer of hydroxyl terminated polybutadiene in order to obtain a homogenous distribution of the agglomerate in the particles.

After the mixing phase the di-isocyanate is added and possibly a catalyst followed by a new mixing phase for the homogenisation.

After the final mixing the material is compressed at a temperature between 30-90° C., for a period that can vary from between 1 minute to 3 days (depending on the type of (di-isocyanate, the temperature and the use or not of a catalyst) to obtain the agglomeration slabs.

Using these reagents in the cork particle agglomeration process and in particular with cork powder and ‘soils’ and with wood particles such as wood chip, fibre dust, polish dust, saw mill and saw dust results in highly agglomerated solid products which have good mechanical resistance and flexibility.

This new agglomeration process is intended to be an alternative to current agglomerates used in cork and wood agglomerates. However in addition it intends in particular to be able to agglomerate particles of a low granulometry and in this way to reprocess sub-products and residues from cork powder, ‘terras’, sawdust, fibre dust and polish dust from wood agglomerates.

New products are created through this agglomeration process, such as particle agglomerations with up to 95% cork powder and/or ‘terras’, particle agglomerations with up to 95% sawmill or saw dust and/or fibre dust and/or polish dust. These new agglomerates have good macroscopic characteristics (in relation to the finish quality for use as low granulometry particles) and physical and mechanical properties with a high potential for industrial applications. These products are used for the production of wood agglomerate panels and veneers (wood particles boards) and in the production of cork agglomerates (acoustic and thermal insulation slabs, pavements, skirting boards, notice boards etc) and in the production of mixed agglomerates (wood and cork).

The resulting product from the agglomeration process of particles of wood and cork including the low granulometry particles (less than 0.2 mm, the subject of this invention, can be obtained in the following ways:
In a continuous production line in an integrated system of mixing, compression and cutting with the injection of reagents and temperature control;
In a discontinuous production line which includes the mixing and compression phases with temperature control;
In a discontinuous production line in an individual system of mixing, mould filling, mould compression, greenhouse placement and mould removal.

This process therefore enables the industrial reprocessing and/or optimisation of products, sub-products and residues of sectors of wood and cork and at the same time plays its part in solving environmental problems by creating a viable and profitable alternative to the storage and/or depositing in the ground, especially for cork powder and ‘terras’ classified as industrial residues (Code LER 03 01 99) and some wood residues, in particular fibre and polishing dust.

The application of this agglomeration process to already existing agglomerates, as a substitution for current agglomerates, results in an improvement in the properties and characteristics of those products, in particular in relation to their mechanical properties and their waterproofing. It must also be noted that in the case of wood particle agglomerates, the agglomeration process of this invention enables formaldehyde-free products to be obtained and it creates an efficient agglomeration that is more or less independent of the nature of the wood chip (wood chip from resin trees such as pine trees or from hardwoods such as eucalyptus or wood chippings with bark), whereas the agglomeration efficiency of current agglomerations is significantly reduced through wood chip from hardwood and wood chip with bark.

The particle agglomeration process of wood and cork sectors, including particles of low granulometry (lower than 0.2 mm), the subject of this invention can be used in the production of particle agglomerations in the following situations:

Through the separate agglomeration of wood and cork particles;
1. Agglomeration of cork granules and/or cork powder and/of “terras”;
2. Agglomeration of wood chips and/or saw mill and/or fibre dust and/or polish dust;

Through the combined agglomeration of wood and cork particles;
1. Mixed agglomerates (homogenous wood and cork particles)
2. Mixed agglomerates (heterogeneous wood and cork particles) in particular consisting of independent wedges of cork and wood agglomerate, aggregated or juxtaposed, for example in a type of ‘sandwich’ arrangement).

In this sense the particle agglomeration process of wood and cork sectors including low granulometry particles (less than 0.2 mm)—the subject of this invention—may be applied to any type of wood production installation and in particular to wood agglomerates used for the manufacture of panels or boards of particles and the manufacture of veneers, plywood, lamellas and other panels (sub-sector of panels and veneers) plus to the sub-sector of cork agglomerates (in particular in the production of wedges, pavements, supports, thermal and acoustic and anti-vibration insulation, agglomerated frames and bottle corks).

The probable markets are:

Products obtained from the cork particles:
a) Construction sector such as in thermal and acoustic insulation slabs, pavements, ceiling insulating slabs, skirting boards, etc.
b) Cork sector itself such as bottle corks of agglomerated material etc.

Products obtained from the cork and/or wood particles:
a) Footwear sector such as for soles, insoles, heels etc.
b) The automotive industry

Products obtained from wood particles:
The entire current market for wood particles agglomerates or particles boards.

### DETAILED DESCRIPTION OF THE INVENTION

1. Mixture of cork and/or wood particles with the agglomerate.

1.1. Addition or injection of hydroxyl terminated polybutadiene at a temperature between 30 and 200° C., normally between 40 and 100° C., in an industrial mixture loaded with a pre-determined mass (load) of particles in a percentage between 5 and 60% (m/m), normally between 10 and 25% (m/m), relative to the mass of particles and a catalyst between 0 (zero) and 1600 ppm, normally between 0 (zero) and 500 ppm, relative to the mass of hydroxyl terminated polybutadiene;

1.2. Mixture of the components in paragraph a) for the homogenisation for a period of time between 10 and 60 minutes, normally between 15 and 30 minutes;

1.3. Addition or injection in the mixer of a di-isocyanate at a temperature between 10 and 40° C., normally between 15 and 25° C., in a percentage between 5 and 25% (m/m), normally between 8 and 20% (m/m), relative to the mass of hydroxyl terminated polybutadiene groups;

1.4. Mixture of the components in the previous paragraphs for the homogenisation for a period of time between 5 and 30 minutes, normally between 5 and 15 minutes.

2. Compression of the mixture of cork and/or wood particles with the agglomerate.

The particle mixture is added to the agglomerate system, referred to in the previous point, in order to form a layer usually known as ‘mattress’ which enables the compression as follows:

2.1. In a continuous system

In a continuous production line, the mixture is then deposited on a conveyor belt, forming what is called a ‘mattress’ in the sector and compressed under movement at a temperature between 30° C. and 90° C. for the time required for the polymerisation and for a solid slab of particle agglomerate to be obtained and this normally takes between 3 and 30 minutes;

2.2. In a discontinuous system

In a discontinuous production system, the mixture is deposited in a fixed compression press, which as a rule consists of various tray-type landing-areas which enable the compression of various slabs at the same time and the ‘mattress’ is compressed at a temperature between 30° C. and 90° C. for the time required for the polymerisation and for a solid slab of particle agglomerate to be obtained and this normally takes between 3 and 30 minutes;

2.3. Compression in a mould

Alternatively the mixture is deposited and compressed into a mould. The mould is placed in a greenhouse for the time required for the polymerisation, generally for 10-120 minutes at a temperature varying 40° C. and 90° C., and then it is removed from the mould to obtain a solid slab of particle agglomerate.

### EXAMPLES

The following examples will help illustrate and display the invention through its operational details.

### Example 1

For the application of the process that is the subject of this invention the steps below must be followed:
Mechanical mixture of 17.6% (m/m) of pine wood chip with bark, 17.6% of eucalyptus wood chip with bark, 24.4% recycled wood chip and 26.4% saw mill;
Addition to the earlier composition of 10.9% (m/m) hydroxyl terminated polybutadiene and of 1.1% (m/m) of a di-isocyanate followed by the mixture for a period of 15 minutes for a more or less homogenous distribution of the agglomerate by the particles;
Placing of the mixture in a press or mould for a period of 2 hours at 60° C.;

A panel of particle agglomerate is obtained with a density of 652 kg/m³, a traction resistance of 0.81 N/mm² and a swelling percentage at 2 hours of 1.9% and at 24 hours of 7.6%.

### Example 2

For the application of the process that is the subject of this invention the steps below must be followed:
Mechanical mixture of 8.0% (m/m) of pine wood chip with bark, 16.0% of eucalyptus wood chip with bark, 24.0% recycled wood chip and 32.0% saw mill;
Addition to the earlier composition of 17.4% (m/m) hydroxyl terminated polybutadiene and of 2.6% (m/m) of a di-isocyanate followed by the mixture for a period of 15 minutes for a more or less homogenous distribution of the agglomerate by the particles;
Placing of the mixture in a press or mould for a period of 2 hours at 60° C.;

A panel of particle agglomerate is obtained with a density of 654 kg/m³, a traction resistance of 0.96 N/mm² and a swelling percentage at 2 hours of 0.9% and at 24 hours of 3.6%.

### Example 3

For the application of the process that is the subject of this invention the steps below must be followed:
Mechanical mixture of 17.0% (m/m) of pine wood chip with bark, 17.0% of eucalyptus wood chip with bark, 25.5% recycled wood chip and 25.5% saw mill;
Addition to the earlier composition of 13.6% (m/m) hydroxyl terminated polybutadiene and of 1.4% (m/m) of a di-isocyanate followed by the mixture for a period of 15 minutes for a more or less homogenous distribution of the agglomerate by the particles;
Placing of the mixture in a press or mould for a period of 2 hours at 60° C.;

A panel of particle agglomerate is obtained with a density of 636 kg/m³, a traction resistance of 0.74 N/mm2 and a swelling percentage at 2 hours of 1.1% and at 24 hours of 5.3%.

### Example 4

For the application of the process that is the subject of this invention the steps below must be followed:
Mechanical mixture of 70.0% (m/m) of cork powder (particle with a dimension less than 0.2mm) and 10% ‘terras’ (particles originating from the exterior layer of the cork wedges);
Addition to the earlier composition of 17.4% (m/m) hydroxyl terminated polybutadiene and of 2.6% (m/m) of a di-isocyanate followed by the mixture for a period of 20 minutes for a more or less homogenous distribution of the agglomerate by the particles;
Placing of the mixture in a press or mould for a period of 2.5 hours at 60° C.;

A panel of cork agglomerate is obtained with a density of 500 kg/m³, a breaking resistance of 2,405 MPa, a modulus of 79.26 MPa and a distortion percentage of 10.06%.

### Example 5

For the application of the process that is the subject of this invention the steps below must be followed:
Mechanical mixture of 80.0% (m/m) of wood fibre with 17.4% (m/m) hydroxyl terminated polybutadiene and of 2.6% (m/m) of a di-isocyanate for a period of 15 minutes to obtain a more or less homogenous distribution of the agglomerate by the particles;
Placing of the mixture in a press or mould for a period of 2 hours at 60° C.;

A panel of wood fibre dust agglomerate is obtained with an average density on the sides of 751 kg/m³, an average density in the nucleus of 762 kg/m³, an internal resistance of 0.91 N/mm² and a swelling at 24 hours of 2.8%.

1. A particle agglomeration process from wood and cork sectors comprising:
a) mixing of wood and/or cork particles with a binder comprising hydroxyl terminated polybutadiene and a di-isocyanate;
b) pressing of the mixture, either in a presser or mould, until a solid panel of particle agglomerate in a determined density is obtained.

2. Process, according to claim 1, wherein the agglomerate is a hydroxyl terminated polybutadiene, a di-isocyanate and a reaction catalyst.

3. Process, according to claim 1, wherein the pressing of the cork and/or wood particles is carried out in a presser or mould at a variable temperature between 30° C. and 90° C.

4. Use of the particle agglomeration process of wood and cork sectors, according to claim 1, wherein the process is applied in the production of panels or wedges of cork and/or slab agglomerates (particles boards).

5. Use of the particle agglomeration process of wood and cork sectors, according to according to claim 4, wherein the process is applied in the production of panels or slabs of cork and/or wood agglomerates presenting different densities.

6. Use of the particle agglomeration process of wood and cork sectors, according to claim 4, wherein the process is applied in the production of panels or slabs of cork agglomerates.

7. Use of the particle agglomeration process of wood and cork sectors, according to claim 4, wherein the process is applied in the production of panels or slabs of wood agglomerates.

8. Use of the particle agglomeration process of wood and cork sectors, according to claim 4, wherein the process is applied in the production of panels or slabs of mixed agglomerates of cork and wood.

9. Process, according to claim 2, wherein the pressing of the cork and/or wood particles is carried out in a presser or mould at a variable temperature between 30° C. and 90° C.

10. Use of the particle agglomeration process of wood and cork sectors, according to claim 9, wherein the process is applied in the production of panels or wedges of cork and/or slab agglomerates (particles boards).

11. Use of the particle agglomeration process of wood and cork sectors, according to claim 2, wherein the process is applied in the production of panels or wedges of cork and/or slab agglomerates (particles boards).

12. Use of the particle agglomeration process of wood and cork sectors, according to claim 3, wherein the process is applied in the production of panels or wedges of cork and/or slab agglomerates (particles boards).

13. Use of the particle agglomeration process of wood and cork sectors according to claim 10, wherein the process is applied in the production of panels or slabs of cork and/or wood agglomerates presenting different densities.

14. Use of the particle agglomeration process of wood and cork sectors, according to claim 5, wherein the process is applied in the production of panels or slabs of cork agglomerates.

15. Use of the particle agglomeration process of wood and cork sectors, according to claim 5, wherein the process is applied in the production of panels or slabs of wood agglomerates.

16. Use of the particle agglomeration process of wood and cork sectors, according to claim 5, wherein the process is applied in the production of panels or slabs of mixed agglomerates of cork and wood.
